(19) United States
(12) Patent Application Publication
(10) Pub. No.: US 2026/0320812 A1
(43) Pub. Date: Oct. 15, 2026

(54) OPTICAL DEPTH SENSING SYSTEMS AND METHODS OF ESTIMATING DEPTHS OF OBJECTS USING OPTICAL ASSEMBLIES

(71) Applicants: Purdue Research Foundation, West Lafayette, IN (US); Northwestern University, Evanston, IL (US)

(72) Inventors: Qi Guo, West Lafayette, IN (US); Yuxuan Liu, West Lafayette, IN (US); Junjie Luo, West Lafayette, IN (US); Emma Alexander, Evanston, IL (US)

(21) Appl. No.: 19/648,445

(22) Filed: Apr. 15, 2026

Related U.S. Application Data
(60) Provisional application No. 63/786,578, filed on Apr. 10, 2025.

(51) Int. Cl. G06T 7/50; G01B 11/22; G02B 15/04; H04N 23/20; H04N 23/55

(52) U.S. Cl. CPC G06T 7/50; G01B 11/22; G02B 15/04; H04N 23/20; H04N 23/55; G06T 2207/10048; G06T 2207/10148

(57) ABSTRACT

Optical depth sensing systems and methods of estimating depths of objects. An optical depth sensing system includes an optical assembly and a computer processor. The optical assembly includes a deformable lens for dynamically adjusting optical power of the optical assembly, an adjustable iris for dynamically adjusting aperture dimension of the optical assembly, and a digital image sensor for capturing an image of a fixed scene projected through the deformable lens and the adjustable iris. The computer processor obtains a coupled pair of optical derivatives of a defocused image of an object in the fixed scene from the optical assembly and determines the depth of the object from the optical derivatives. The method calculates the depth of an object in an image from coupled optical differentiation, which determines per-pixel object depth (distance) from a coupled pair of optical derivatives of a defocused image.

### CROSS-REFERENCE TO RELATED APPLICATIONS

This application claims the benefit of provisional U.S. Patent Application No. 63/786,578 filed Apr. 10, 2025, the contents of which are incorporated herein by reference.

### BACKGROUND OF THE INVENTION

The invention generally relates to systems and methods of estimating depths of objects using an optical assembly.

The ability to perceive object depths at very low power consumption and without using time-resolved or space-resolved illumination is prevalent in nature. For example, jumping spiders, praying mantis, and other animals have passive-lighting depth sensing capabilities in their visual systems. However, it has been extremely challenging to embed a passive-lighting depth sensor in miniature artificial systems, such as micro-robots, microsensors, wearable devices, for example. A major reason for this difficulty is that passive-lighting depth sensors typically require sophisticated and processing heavy computational operations to extract depth information from the raw measurements.

Conventional artificial depth sensing systems have included both active-illumination systems, such as active-illumination systems and structured light systems, and passive-illumination systems, such as learning-based 2D-to-3D lifting systems, stereo systems, and depth (distance) from defocus systems. However, the active-illumination systems typically require complex hardware and high power consumption to generate the necessary illumination and are susceptible to background noise and multipath interference of complex scene structures. The depth from defocus systems, on the other hand, do not require actively generating illumination, but typically have small effective working ranges, typically shorter than 60 cm. In addition, the signal-to-noise ratio typically becomes low when the object is out of the depth of field. Furthermore, these known systems typically have high computational costs, for example, ranging from about 600 floating point operations per output pixel (FLOPOP) to over 7000 FLOPOP and higher. Therefore, it would be desirable to have an optical depth sensing system that can improve on one or more of these conventional systems.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, methods of estimating depths (distances) of objects and monocular optical depth sensing systems.

According to a nonlimiting aspect, a method is provided for estimating a depth of an object in a fixed scene from a single optical assembly. The method includes obtaining a coupled pair of optical derivatives of a defocused image of the object from the single optical assembly and determining the depth of the object from the optical derivatives.

According to another nonlimiting aspect, a monocular optical depth sensing system includes an optical assembly and a computer processor. The optical assembly includes a deformable lens for dynamically adjusting optical power of the optical assembly, an adjustable iris for dynamically adjusting aperture dimension of the optical assembly, and a digital image sensor for capturing an image of a fixed scene projected through the deformable lens and the adjustable iris. The computer processor is configured to obtain a coupled pair of optical derivatives of a defocused image of an object in the fixed scene from the optical assembly and determine the depth (distance) of the object from the optical derivatives.

Technical aspects of systems, sensors, and/or methods as described above preferably include the ability to obtain object depth estimates from images with a relatively long working range and relatively low computational complexity.

These and other aspects, arrangements, features, and/or technical effects will become apparent upon detailed inspection of the figures and the following description.

### BRIEF DESCRIPTION OF THE DRAWINGS

FIG. 1 is a diagrammatic representation of a monocular optical depth sensing system according to a nonlimiting aspect of the invention.

FIG. 2 illustrates a method of estimating a depth of an object from a single optical assembly according to a nonlimiting aspect of the invention.

FIG. 3 illustrates a method of obtaining a coupled pair of optical derivatives from a single optical assembly according to another nonlimiting aspect of the invention.

FIG. 4 illustrates a method of calculating the depth of an object using information from the coupled pair of optical derivatives.

FIG. 5 illustrates some principles of the system for calculating depth-from-coupled optical differentiation according to some aspects of the present invention.

FIG. 6 illustrates the capture of two pairs of images that can be used to obtain a coupled pair of optical derivatives.

### DETAILED DESCRIPTION OF THE INVENTION

The intended purpose of the following detailed description of the invention and the phraseology and terminology employed therein is to describe one or more nonlimiting embodiments of the invention, and to describe certain but not all aspects of what is depicted in the drawings, including the embodiment(s) to which the drawings relate. The following detailed description also describes certain investigations relating to the embodiment(s) and identifies certain but not all alternatives of the embodiment(s). As nonlimiting examples, the invention encompasses additional or alternative embodiments in which one or more features or aspects shown and/or described as part of a particular embodiment could be eliminated and also encompasses additional or alternative embodiments that combine two or more features or aspects shown and/or described as part of different embodiments. Therefore, the appended claims, and not the detailed description, are intended to particular point out subject matter regarded to be aspects of the invention, including certain but not necessarily all of the aspects and alternatives described in the detailed description.

As used herein the terms “a” and “an” to introduce a feature are used as open-ended, inclusive terms to refer to at least one, or one or more of the features, and are not limited to only one such feature unless otherwise expressly indicated. Similarly, use of the term “the” in reference to a feature previously introduced using the term “a” or “an” does not thereafter limit the feature to only a single instance of such feature unless otherwise expressly indicated.

Disclosed herein are embodiments of a 3D depth sensing system 10 and methods for determining the depth of an object in an image from coupled optical differentiation. The sensing system 10 may be utilized as a low-computation passive-lighting 3D sensing system and operate on the basis of depth-from-coupled optical differentiation, which includes rigorously determining per-pixel object depth (distance) from a coupled pair of optical derivatives of a defocused image using a simple, closed-form relationship. Unlike previous depth-from-defocus (DfD) methods that leverage spatial derivatives of the image to estimate scene depths, the sensing system 10 is able to use only optical derivatives, which makes it significantly more robust to noise. Furthermore, unlike many previous DfD algorithms with requirements on aperture code, this relationship is shown to be universal to a broad range of aperture codes. In some arrangements, the sensing system 10 may be utilized to capture four images of a fixed scene with different optical settings and produce a sparse depth map with as few as thirty-six floating point operations per output pixel (FLOPOPs).

Embodiments of the sensing system 10 preferably utilize an optical assembly 11 equipped with an adjustable (e.g., motorized) iris 12 and a deformable lens 14, which enable dynamic adjustments to the size (radius) of the aperture 13 of the adjustable iris 12 and the optical power of the deformable lens 14. The optical assembly 11 captures two pairs of images: one pair with a differential change of optical power and the other pair with a differential change of aperture scale. From the four images, a depth and confidence map can be generated with as few as thirty-six FLOPOPs, which is more than ten times lower than previously known passive-lighting depth sensing solutions. Additionally, the depth map generated by the sensing system 10 has been shown to have more than twice the working range of previous DfD methods while using significantly lower computation resources.

The sensing system 10 is preferably capable of capturing images/with dynamically controlled optical power p and aperture radius A using the deformable lens 14 and the adjustable iris 12, respectively, to estimate image derivatives with respect to these two optical parameters, i.e., I_{ρ} and I_{A}, via finite difference. A depth map can then be estimated via a per-pixel calculation using the two image derivatives:

$$Z = \frac{a}{b - I ρ / IA} \qquad ( eq . 1 )$$

where the parameters a and b are pre-calibrated constants determined by the optical setup of the optical assembly 11. Using this method of obtaining depth measurements from coupled optical differentiation, theoretically, the depth of objects can be estimated at every pixel in an image of a static scene using image derivatives with respect to the two optical parameters I_{ρ} and I_{A}.

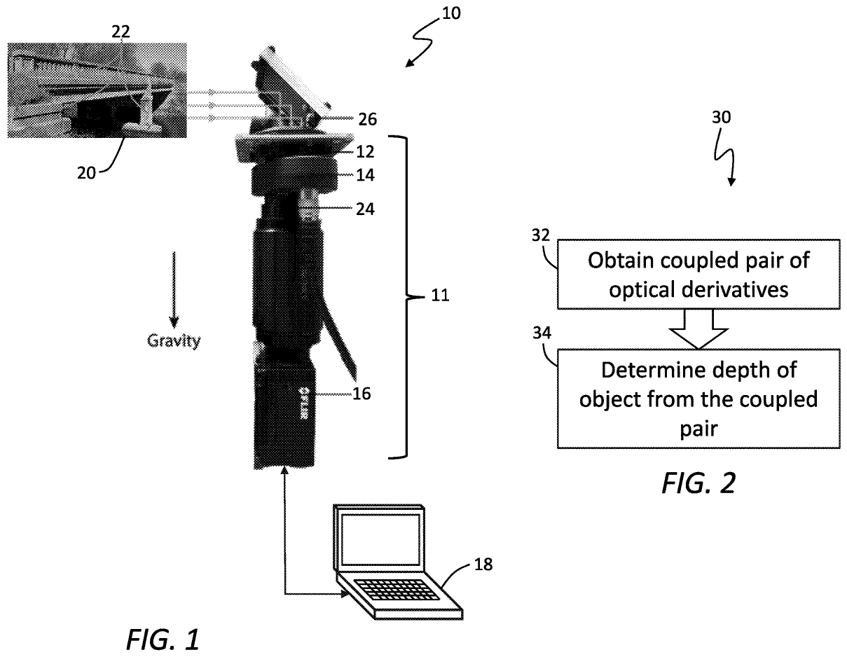

FIG. 1 schematically represents a nonlimiting embodiment of the sensing system 10 that is referred to herein as a monocular optical depth sensing system 10 that includes the optical assembly 11 configured as a monocular optical image capture system (e.g., a camera) that includes the adjustable iris 12, the deformable lens 14, and a photosensor 16. The sensing system 10 of FIG. 1 further includes a computer processor 18 in data communication with the photosensor 16 of the optical assembly 11. The adjustable iris 12 is configured to regulate the amount of light energy from an optical scene 20 that can pass through the deformable lens 14. The deformable lens 14 is configured to control the focus of the optical scene 20 upon the photosensor 16. The photosensor 16 is configured to capture an image of the scene 20 as viewed through the deformable lens 14 and the adjustable iris 12. The computer processor 18 is configured with appropriate software and/or hardware to receive the image information from the photosensor 16 and determine the depth of one or more objects 22 within the image from a coupled pair of optical derivatives obtained from pairs of defocused images of the scene 20 that provide known differential changes in at least a first optical parameter and a second optical parameter, as discussed in further detail hereinafter. In this example, the first and second optical parameters relate to the size of the aperture 13 of the adjustable iris 12 and the optical power of the deformable lens 14; however other optical parameters could be used. Optionally, the system 10 also includes a fixed focus lens 24 disposed along the optical path between the deformable lens 14 and the photosensor 16 to adjust the overall working range of the sensing system 10. Additional components, such as mirror(s), support stand(s), electrical source(s), and data transfer device(s) may also be incorporated in any suitable manner to support operation of the sensing system 10 as described herein.

The adjustable iris 12 is configured to adjust the dimension of its aperture 13 between various different known aperture sizes. The adjustable iris 12 may be, for example, a motorized iris that includes a motor that precisely adjusts its aperture size according to control inputs to provide an aperture size known to within a high accuracy threshold. In one embodiment, the adjustable iris 12 is configured to dynamically adjust its diaphragm between about 1 mm and 12 mm in diameter; however, other types of adjustable irises could be used depending on the specific use requirements and/or constraints of a given sensing system 10.

The deformable lens 14 is configured to adjust the optical power of the optical assembly 11 to adjust the focus of the captured image received at the photosensor 16. The deformable lens 14 may be, for example, an electric tunable lens or another type of deformable lens that allows the lens 14 to be dynamically adjusted between various different known optical powers.

The photosensor 16 may be a digital image sensor, such as a CMOS (complementary metal-oxide semiconductor), CCD (charge-coupled device), SPAD (single photon avalanche diode), EMCCD (electron-multiplying CCD), or other type of digital image sensor. In one embodiment, the photosensor 16 includes a FLIR (forward looking infrared) sensor for detecting heat and/or other non-visible electromagnetic radiation under low visible light conditions that might otherwise prevent the sensing system 10 from obtaining sufficient light information to capture a useful image of the scene 20.

Unlike some conventional sensing systems, the sensing system 10 is a passive-lighting sensor that is configured to be able to calculate the depth of objects in images of the scene 20 from passive, ambient light without the use of active-light emissions from the system 10 itself. Thus, although additional active light emission technology may be added to the sensing system 10 if desired, such active light emission is not necessary for operation and determination of object depths (distances) from images captured by the sensing system 10. For this reason, the use of a FLIR sensor or other type of low visible light sensor can be particularly advantageous for calculating object depths in low light situations, such as at night or in areas with no or low visible light where primarily only radiative emissions from heat would be detectable, for example.

The optical components (adjustable iris 12, lenses 14 and 24, and photosensor 16) of the sensing system 10 may be arranged in any suitable arrangement configured to transmit an image of the scene 20 to the photosensor 16 with desired light capture (e.g., controlled by the adjustable iris 12) and focal quality (e.g., controlled by the lenses 14 and/or 24). In the present example, however, the optical components are arranged vertically (i.e., parallel with the local force vector of gravity) to reduce potential optical aberrations of the deformable lens that might be caused by gravity. This vertical configuration can thereby increase the sensitivity and/or accuracy of the object depths obtained therefrom. To achieve this vertical configuration, one or more mirrors 26 may be incorporated and configured to redirect light energy transmitted from the scene 20 through the adjustable iris 12 and lenses 14 and 24 to the photosensor 16.

The computer processor 18 may be any combination of computer hardware and/or software suitable for and configured to estimate the dept of objects 22 from images obtained by the optical components in the system 10, for example, by implementing any one or more of the various methods described herein. The computer processor 18 may include a single processing unit or may include multiple processing units working together or separately. Image data and information captured by the photosensor 16 may be transferred to the computer processor 18 in any suitable manner, such as over one or more wired or wireless data connections, and/or by transfer of one or more hard data storage devices, such as memory storage devices.

FIG. 2 illustrates steps in a method 30 of estimating the depth of one or more of the objects 22 in the scene 20. The method 30 may be implemented by the computer processor 18 to process a set of images of the scene 20 obtained by the photosensor 16. At 32, a coupled pair of optical derivatives obtained from defocused images of the object 22 are obtained from the photosensor 16. The coupled pair of optical derivatives may include a first image derivative of a first optical parameter and a second image derivative of a second optical parameter. The optical derivatives of the first and second parameters may be coupled by obtaining a first differential change in the first optical parameter while holding the second optical parameter constant and then obtaining a second differential change in the second parameter while holding the first optical parameter constant.

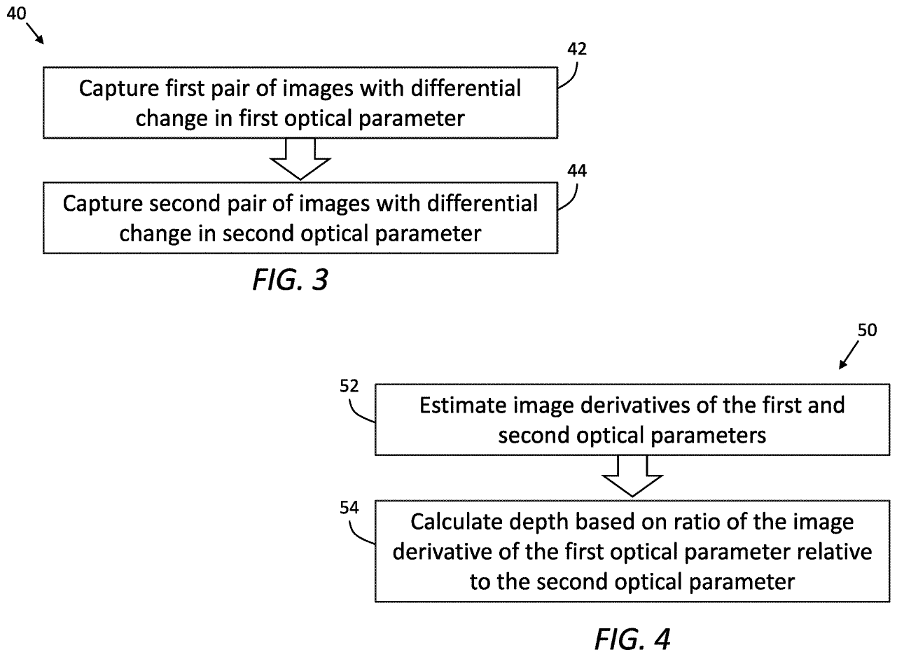

FIG. 3 represents an example of a method 40 for obtaining a coupled pair of optical derivatives includes capturing two pairs of images (four images total) of the scene 20 with the object 22 therein. The four images are obtained with the monocular optical image capture assembly (optical assembly) 11 of the system 10 such that the scene 20 remains in the same fixed position relative to the optical assembly 11 across all four of the captured images. For example, the position of the optical assembly 11 relative to an object in the scene is the same for each of the images. The image data from each captured image is retained in a memory for subsequent use by the computer processor 18. At 42, a first pair of images is captured in which a differential change is made between the two images of the first optical parameter and the second optical parameter is maintained constant. For example, the first pair of images may vary the optical power of the deformable lens 14 such that the first image is defocused a known deviation amount from the second image while other optical parameters of the optical assembly 11 are held constant. At 44, a second pair of images is captured in which a differential change is made between another two images of a second optical parameter while the first optical parameter is maintained constant. For example, the second pair of images may vary the aperture size of the adjustable iris 12 such that aperture size used to capture the third image deviates a known amount from the aperture size used to capture the fourth image while other optical parameters of the optical assembly 11 are held constant. In this way, a set of four images are captured in order to obtain a coupled pair of optical derivatives of the optical power of the deformable lens 14 and the aperture size of the adjustable iris 12.

Referring again to FIG. 2, at 34 the depth(s) of one or more objects 22 in the captured images of the scene 20 are determined from the coupled pair of optical derivatives. The depths may be calculated on a pixel-by-pixel basis for each corresponding pixel in the four captured images. The depth(s) may be determined using the computer processor 18 implementing a program that executes a series of calculation steps to calculate the depth(s) from the image data obtained from the four images.

With reference to FIG. 4, a method 50 of determining the depths of objects. includes at 52 estimating the image derivatives of each of the first optical parameter and the second optical parameter based on the image information in the four images. At 54, the depth of an object is then calculated based on a ratio of the image derivative of the first optical parameter relative to the image derivative of the second optical parameter. The depth calculations may be performed on a pixel-by-pixel basis for each common scene pixel of the four images to generate a depth and confidence map for all or some subset of the common scene pixels. Advantageously, by basing the calculations using the ratio of the image derivatives of the two optical parameters, the depth and confidence calculation for each pixel in the map may be obtained with as few as thirty-six FLOPOPs. Thus, the method 50 can provide depth information for objects in the image at an approximately 10× savings in computing resources, which allows for faster and cheaper depth estimation that may improve real time uses of the sensing system 10 for a wide variety of automated and/or autonomous dynamic operating scenarios, such as the autonomous computerized operation of various types of machinery.

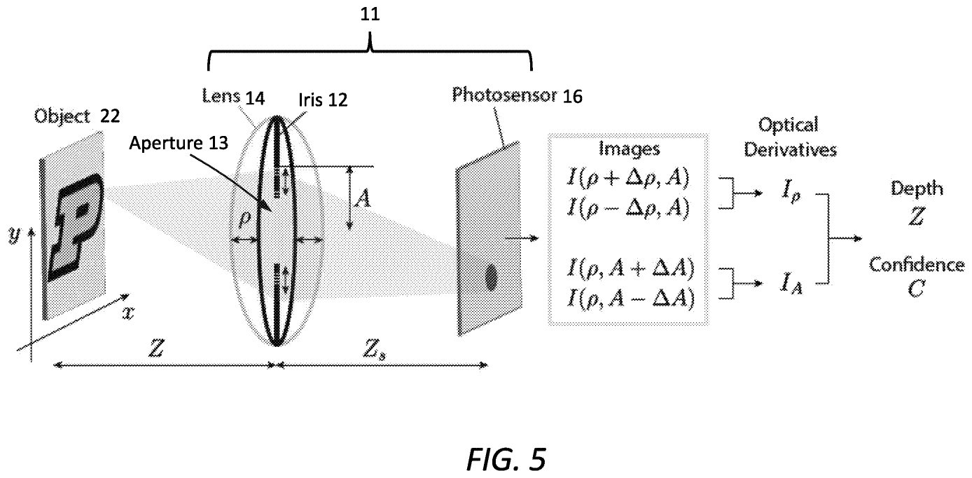

FIG. 5 illustrates basic theoretical principles implemented by the sensing system 10. A theoretical thin-lens optical assembly 11 has an aperture-to-sensor distance Zs, adjustable optical power p, and adjustable aperture radius A. The image captured by the photosensor is a function of these two optical parameters, ρ and A, denoted as I(ρ, A). The ratio of the optical derivatives, IA/Iρ, reveals the object depth (distance) Z at each pixel through closed-form solutions. The depth map of an image can then be obtained from the following relation:

$$\to Z ( x , y ) = \frac{{Z}_{s}}{{Z}_{s} ρ - 1 - {AZ}_{s} \cdot {I}_{A} ( x , y ) / {I}_{ρ} ( x , y )} . \qquad ( eq . 2 )$$

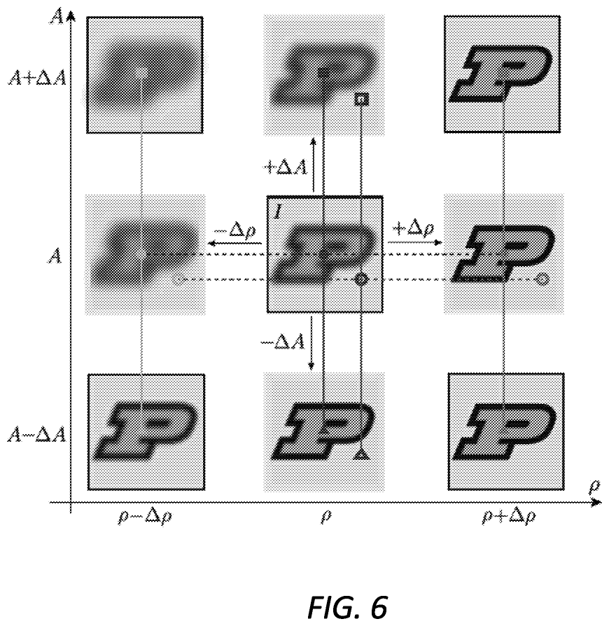

FIG. 6 demonstrates the four images of the same object captured with different optical power p and aperture radius A illustrated in FIG. 5. By adjusting the optical parameters p and A, the optical assembly 11 can capture images I of the object with different defocus levels. In practice, the sensing system 10 may be configured to capture the four highlighted images I(ρ+Δp,A), I(ρ−Δρ,A), I(ρ,A+ΔA), I(ρ,A−ΔA) to estimate the optical derivatives Iρ and IA via finite difference.

Obtaining the optical derivatives involves physically adjusting the optical assembly 11 and measuring the finite differences. For example, the derivative of optical power ρ is calculated as:

$${I}_{ρ} = \frac{I ( ρ + Δρ ) - I ( ρ - Δρ )}{2 Δ ρ} , \qquad ( eq . 3 )$$

for the focus-tunable deformable lens 14 set to ρ+Δρ. The derivative of a circular aperture A for the adjustable iris 12 can be obtained as

$$I ( A + Δ A ) = {( \frac{A}{A = Δ A} )}^{2} \tilde{I} ( A + Δ A ) , \qquad ( eq . 4 )$$

where Ĩ (A+ΔA) is the raw captured image with aperture radius A+ΔA. From these, the depth sensing system 10 can perform coupled optical differentiation (ΔA, Δφ using the optical assembly 11 of the sensing system 10.

Investigations have shown that the finite difference estimation of image derivatives becomes inaccurate when the captured images are close to focus. For example, when changing the optical power ρ, the pixel intensity I is constant when the object is in the depth-of-field. In addition, the pixel intensity I also remains constant with respect to the aperture radius A if the object is in focus. This indicates that both image derivatives I_{ρ} and I_{A} go to zero when the object is in focus. To counteract this phenomenon, it is preferable to obtain defocused images for all four of the captured images. In addition, this method also fails in image regions that lack spatial variation in intensity, for example, where the image intensity stays constant with respect to changes of the focal and aperture optical parameters ρ and A, respectively at a pixel in a textureless region of the image resulting in both image derivatives I_{ρ} and I_{A} again going to zero. Fortunately, this situation can be detected directly from the values of image derivatives I_{ρ} and I_{A}, which can inform confidence C of the depth estimation to filter out bad pixels. For example, pixels with failed depth estimations can be identified using a per-pixel confidence metric based on the derivative magnitude of the square of the respective derivative I_{ρ} and I_{A} and then filter out pixels that do not meet a predetermined fixed confidence threshold. Investigations have shown this to be an effective confidence metric that can be used to filter out erroneous depth estimations in both simulations and real-world experiments.

In investigations leading to the present invention, a prototype generally similar to the sensing system 10 of FIG. 1 was developed that can perform the coupled optical differentiation described in equation 2 above. The optical assembly 11 of the system 10 was constructed of the deformable lens 14 and motorized adjustable iris 12, which can dynamically adjust the optical power ρ and the aperture dimension A, respectively, and a fixed focal length lens to offset the overall optical power of the system. The photosensor of the system was FLIR Grasshopper GS3-U3-23S6M-C. The original resolution of the optical assembly 11 was 1920×1200. The photosensor was configured to bin every 4×4 pixels so that it output 16-bit, 480×300-pixel monochrome images. This way, the readout could achieve the lowest shot noise and discretization noise in the captured images. The optical assembly 11 was configured vertically to reduce the optical aberration of the deformable lens caused by gravity, and a mirror was used to adjust the system's field of view.

Two primary optical aberrations of the optical assembly 11 were identified that can affect the depth sensing accuracy: non-uniform background light in the images, and magnification shifting that occurs when adjusting the optical power of the deformable lens 14. The background light varies when adjusting the aperture dimension A of the adjustable iris 12, while it remains fixed when the optical power ρ changes. Thus, this aberration can significantly impact the estimation of I_{A}, but the estimation of Iρ is unaffected since the aberration can be canceled during the finite difference. This aberration can be attenuated by removing the non-uniform background lighting with a simple equation to provide a clean image derivative of I_{A} that visually matches the intensity profile of the optical derivative I_{ρ}. Relative to the magnification shifting, the magnification of the image slightly changes as the optical power ρ varies, which causes the image of a fixed point source to move its center position. However, the magnification shifting can be ignored when the aperture radius varies or the object depth changes. Therefore, the pair of images that vary the optical power ρ can be geometrically aligned with the corresponding pair of images that vary the aperture size A. In addition, the image noise was calibrated according to a noise model.

The system measured the optical derivatives Iρ and IA via finite difference (Eq. 3) from the four captured images. The finite difference steps Δρ, ΔA are hyperparameters that are determined in advance. The larger Δρ and ΔA, the higher the intensity of Iρ and IA will be, which will be less susceptible to noise. On the other hand, a large Δρ and ΔA will cause the finite difference to deviate from the ground truth derivatives. Therefore, optimal Δρ and ΔA values balance this tradeoff to minimize the depth prediction error relative to a baseline depth map.

Equation 2 estimates the object depth (distance) Z corresponding to each pixel (x,y) only using the image derivatives Iρ, IA at that pixel. In the presence of significant image noise, the depth value at a pixel (x0, y0) can be solved more accurately via least square fitting by aggregating image derivatives of pixels within a small window W centered at (x0, y0), assuming the depth value remains constant within the window W. An increased window dimension improves the depth accuracy but also increases the computational cost and reduces the spatial resolution of the depth map. In the investigations, a window dimension of 5×5 in the prototype was used to balance the accuracy and computational cost.

Results of the investigations using the prototype revealed that the prototype system consistently generated the most accurate depth maps while costing considerably less computation than previously known monocular depth estimation systems based on conventional DfD methods. In addition, the prototype provided a longer working range, thereby allowing it to be more versatile.

In summary, the sensing system 10 and accompanying methods that incorporate the depth-from-coupled optical differentiation may provide significantly improved data processing efficiency and the working range compared to the previously known DfD methods and systems. Investigations into the performance of the sensing system 10 have shown that, in comparison with previous depth from differential defocus theory, which is restricted to only Gaussian point spread functions (PSFs), the system 10 is invariant to differentiable PSF shapes. In addition, investigations have shown that the sensing system 10 provides a significantly higher signal-to-noise ratio than previous depth from differential defocus systems. In addition, the sensing system 10 is able to achieve a significantly longer working range and more accurate depth estimation than previous depth from differential defocus systems.

Additional aspects and advantages of this invention will be further appreciated from nonlimiting embodiments, investigations, etc., described in Exhibit A, which is attached hereto and incorporated herein by reference in its entirety. It should be understood that the invention is not necessarily limited by descriptions, results, conclusions, or other statements that may be contained in Exhibit A, though such statements may have been reasonably based on information and opinions that existed at the time the document(s) contained in Exhibit A was written.

As previously noted above, though the foregoing detailed description describes certain aspects of one or more particular embodiments of the invention, alternatives could be adopted by one skilled in the art. For example, the sensing system 10, the monocular optical assembly 11, and their components could differ in appearance and construction from the embodiments described herein and shown in the drawings, functions of certain components of the sensing system 10 and the monocular optical assembly 11 could be performed by components of different construction but capable of a similar (though not necessarily equivalent) function, and various materials could be used in the fabrication of the sensing system 10, the monocular optical assembly 11, and/or their components. As such, and again as was previously noted, it should be understood that the invention is not necessarily limited to any particular embodiment described herein or illustrated in the drawings.

1. A method of estimating a depth of an object in a fixed scene from a single optical assembly, the method comprising:
obtaining a coupled pair of optical derivatives of a defocused image of the object from a single optical assembly; and
determining the depth of the object from the optical derivatives.

2. The method of claim 1, wherein the step of determining the depth does not comprise using spatial derivatives of the images.

3. The method of claim 1, wherein the step of obtaining a coupled pair comprises:
capturing a first pair of images, comprising a first image and a second image, of the object through the optical assembly, wherein the first pair of images are taken with a first known differential change in a first optical parameter of the optical assembly between the first image and the second image; and
capturing a second pair of images, comprising a third image and a fourth image, of the object through the optical assembly, wherein the second pair of images are taken with a second known differential change in a second optical parameter of the optical assembly between the third image and the fourth image.

4. The method of claim 3, wherein the step of determining the depth is based on the first and second pairs of images, the first known differential change in the first optical parameter, and the second known differential change in the second optical parameter.

5. The method of claim 3, wherein the step of generating the depth and a confidence map is obtained by calculating a ratio of a first image derivative of the first optical parameter relative to a second image derivative of the second optical parameter.

6. The method of claim 3, wherein the first optical parameter comprises optical power of a lens of the optical assembly.

7. The method of claim 6, wherein the lens comprises a deformable lens, and wherein the step of capturing the first pair of images comprises deforming the deformable lens to obtain the first known differential change of the optical power.

8. The method of claim 3, wherein the second optical parameter comprises aperture radius of an iris of the optical assembly.

9. The method of claim 8, wherein the iris comprises an adjustable iris, and wherein the step of capturing the second pair of images comprises adjusting a size of the iris to obtain the second known differential change of the aperture radius.

10. The method of claim 1, wherein the position of the optical assembly relative to the object is the same for each of the images.

11. The method of claim 1, wherein the step of determining the depth comprises generating a depth and confidence map with no more than thirty six floating point operations per output pixel.

12. The method of claim 1, wherein the optical assembly is a monocular optical assembly.

13. The method of claim 1, wherein the optical assembly is a passive lighting sensor.

14. A monocular optical depth sensing system comprising:
an optical assembly comprising:
a deformable lens for dynamically adjusting an optical power of the optical assembly;
an adjustable iris for dynamically adjusting an aperture dimension of the optical assembly; and
a digital image sensor for capturing an image of a fixed scene projected through the deformable lens and the adjustable iris; and
a computer processor configured to:
obtain a coupled pair of optical derivatives of a defocused image of an object in the fixed scene from the optical assembly; and
determine the depth of the object from the optical derivatives.

15. The monocular optical depth sensing system of claim 14, wherein the adjustable iris, the deformable lens, and the digital image sensor are disposed along a vertical axis.

16. The monocular optical depth sensing system of claim 14, further comprising:
a fixed focal length lens optically disposed between the deformable lens and the digital image sensor.

17. The monocular optical depth sensing system of claim 16, wherein the fixed focal length lens is disposed along the vertical axis.

18. The monocular optical depth sensing system of claim 14, wherein the optical assembly is a passive-lighting sensor.

19. The monocular optical depth sensing system of claim 14, wherein the digital image sensor comprises a forward looking infrared sensor.

20. The monocular optical depth sensing system of claim 14, wherein the computer processor is configured to determine the depth of the object by calculating a ratio of a first image derivative of a first optical parameter relative to a second image derivative of a second optical parameter.
